(19) United States
(12) Patent Application Publication
(10) Pub. No.: US 2010/0156261 A1
(43) Pub. Date: Jun. 24, 2010

(54) LIGHT EMITTING DIODE LAMP

(75) Inventor: QING-HAI RUAN, Shenzhen City, Guangdong Province (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City, (CN); FOXCONN TECHNOLOGY CO., LTD., Tu-Cheng, (TW)

(21) Appl. No.: 12/469,676

(22) Filed: May 20, 2009

(30) Foreign Application Priority Data
Dec. 23, 2008 (CN) 200810306489.X

(51) Int. Cl. H01J 7/24

(52) U.S. Cl. 313/46

(57) ABSTRACT

A light emitting diode lamp includes a circuit board and a light emitting diode. The circuit board includes a circuit layer, a bonding layer and a heat conductive layer. The bonding layer is sandwiched between the circuit layer and the heat conductive layer. The light emitting diode is mounted on the circuit layer of the circuit board. The circuit board forms a heat conductive pole corresponding to the light emitting diode. The heat conductive pole extends through the circuit layer and bonding layer. Two ends of the heat conductive pole connect with a substrate of the light emitting diode and the heat conductive layer, respectively.

### BACKGROUND

1. Technical Field

The disclosure relates to LED (light emitting diode) lamps, and more particularly to an improved LED lamp having good heat conductive performance.

2. Description of Related Art

A typical LED lamp includes a circuit board and a plurality of LEDs mounted on the circuit board. The circuit board includes a heat conductive layer, a heat conductive but electrically insulating layer, a bonding layer and a circuit layer, which are upwardly and successively layer-by-layer stacked. The LEDs are mounted on the circuit layer. The heat generated by the LEDs is transferred through the circuit layer, the bonding layer, the insulating layer and then to the heat conductive layer. The bonding layer is generally made of epoxy resin and has a low heat conductivity, which impacts the LED lamp's heat conductive performance.

For the foregoing reasons, therefore, there is a need in the art for an LED lamp which can overcome the limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a partially cross-sectional view of an LED lamp according to an exemplary embodiment.

FIG. 2 is a top, plan view of a circuit board of the LED lamp of FIG. 1.

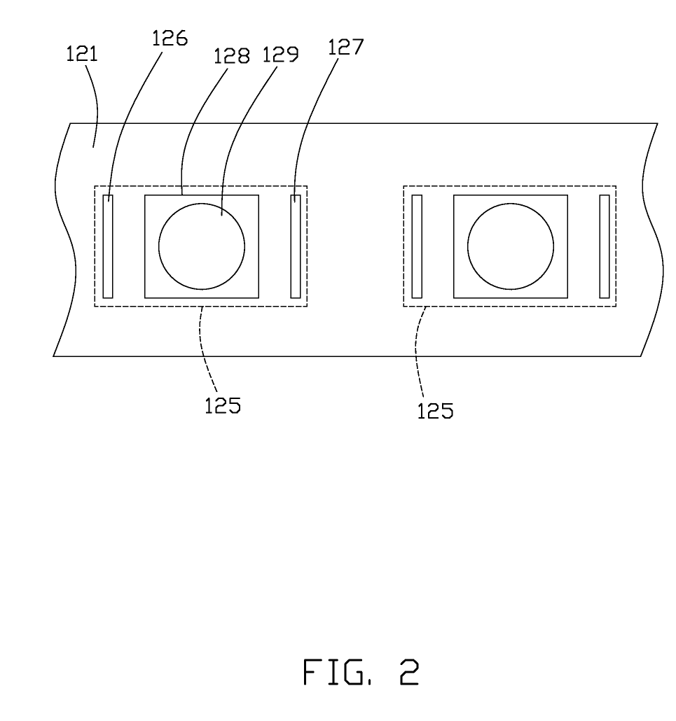

### DETAILED DESCRIPTION

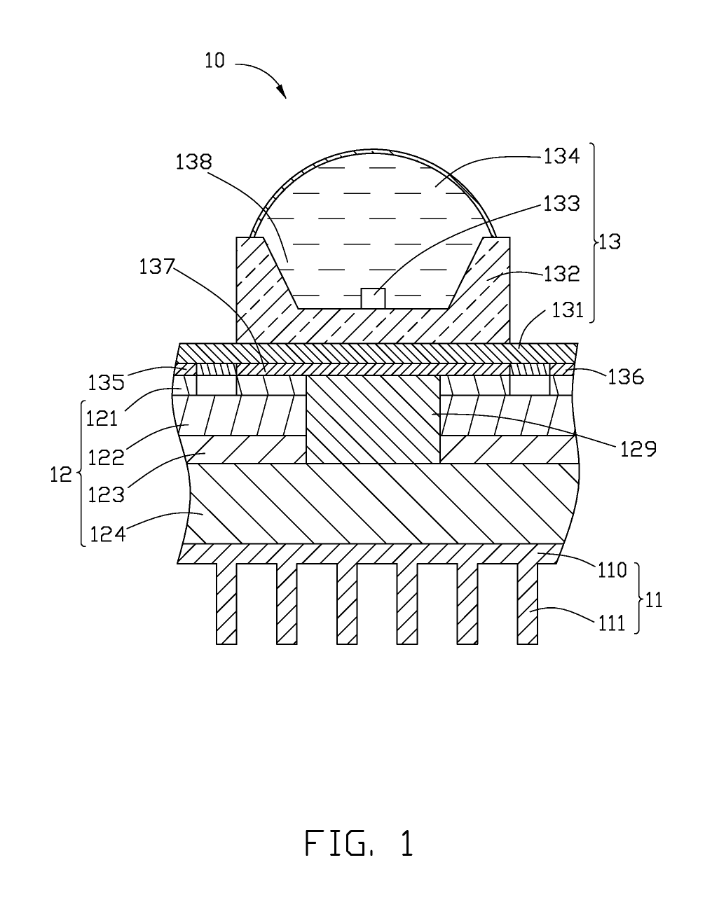

Referring to FIG. 1, a light emitting diode (LED) lamp 10 includes a heat dissipating device 11, a circuit board 12 mounted on the heat dissipating device 11 and a plurality of LEDs 13 mounted on the circuit board 12. The heat dissipating device 11 includes a metal base 110 and a plurality of fins 111 extending downwardly from the base 110.

The circuit board 12 includes a heat conductive layer 124, a heat conductive but electrically insulating layer 123, a bonding layer 122 and a circuit layer 121, which are upwardly and successively layer-by-layer stacked on the heat dissipating device 11. The circuit layer 121 and the heat conductive layer 124 are disposed at a top side and a bottom side of the circuit board 12, respectively. The bonding layer 122 and the insulating layer 123 are sandwiched between the circuit layer 121 and the heat conductive layer 124. The bonding layer 122 is attached to the circuit layer 121 and the insulating layer 123 is attached to the heat conductive layer 124.

The heat conductive layer 124 is mounted on the base 110 of the heat dissipating device 11 and made of a heat conductive metal material, such as aluminum. The insulating layer 123 is made of ceramic and has a good heat conductive property and a good electrical insulation property. The insulating layer 123 is used to perform the electrical insulation function between the circuit layer 121 and the heat conductive layer 124.

The bonding layer 122 is made of epoxy resin. The circuit layer 121 is smoothly and firmly adhered to the insulating layer 123 via the bonding layer 122.

The circuit layer 121 is electrically connected with the LEDs 13. The circuit layer 121 includes a plurality of mounting areas 125 corresponding to the LEDs 13. Each mounting area 125 includes a first electrode 126, a second electrode 127 and a heat conductive section 128, which are spaced from each other. The first electrode 126 and the second electrode 127 are symmetrically disposed at left and right sides of the heat conductive section 128, respectively.

A heat conductive pole 129 is formed in a center of the heat conductive section 128. The heat conductive pole 129 extends vertically through the circuit layer 121, the bonding layer 122 and the insulating layer 123, with a bottom end of the heat conductive pole 129 attached to a top surface of the heat conductive layer 124. The heat conductive pole 129 is made of a heat conductive but electrically insulating material, which has a good heat conductive and electrically insulating property, such as thermal grease. In other embodiments, the heat conductive pole 129 is made of a heat conductive and electrically conductive material, which has a good heat conductive and electrically conductive property, such as metal material.

Each LED 13 includes a substrate 131, a mounting base 132, an LED chip 133 and an encapsulation material 134. The substrate 131 of each LED 13 includes a first electrode 135, a second electrode 136, and a pad 137, which are spaced from each other. The first electrode 135 and the second electrode 136 are symmetrically disposed at left and right sides of the pad 137, respectively. The mounting base 132 is mounted on the substrate 131 and defines a recess 138 therein. The LED chip 133 is disposed in the recess 138 of the mounting base 132 and is encapsulated by the encapsulation material 134.

Each LED 13 is located on a corresponding mounting area 125 of the circuit board 12. The first electrode 135 and the second electrode 136 of the LED 13 are attached to the first electrode 126 and the second electrode 127 of the corresponding mounting area 125, respectively. The pad 137 is attached to the heat conductive section 128 of the corresponding mounting area 125, and a bottom surface of the pad 137 is connected with a top end of the corresponding heat conductive pole 129.

Since the pad 137 of each LED 13 and the heat conductive layer 124 of the circuit board 12 are connected with the top end and the bottom end of the heat conductive pole 129, respectively, each LED 13 is in thermal connection with the heat conductive layer 124 of the circuit board 12 by the heat conductive pole 129. In operation of the LED lamp 10, the heat generated by the LED 13 is directly transferred from the pad 137 of the LED 13 to the heat conductive layer 124 by the heat conductive pole 129, and then the heat is dissipated by the heat dissipating device 11, to thereby improve the heat dissipation of the LED lamp 10 and prolong a lifespan of the LED lamp 10.

It will be obvious that, within the scope of the invention, many variations are possible to those skilled in the art. The scope of protection of the invention is not limited to the example given herein.

What is claimed is:

1. A light emitting diode lamp comprising:
a circuit board comprising a circuit layer, a bonding layer and a heat conductive layer, the bonding layer being sandwiched between the circuit layer and the heat conductive layer;
at least one light emitting diode mounted on the circuit layer of the circuit board, the at least one light emitting diode comprising a substrate;
wherein the circuit board forms a heat conductive pole therein corresponding to the at least one light emitting diode, the heat conductive pole extending through the circuit layer and the bonding layer, two ends of the heat conductive pole connecting with the substrate of the at least one light emitting diode and the heat conductive layer of the circuit board, respectively, whereby heat generated by the at least one light emitting diode is transmitted to the heat conductive layer via the heat conductive pole.

2. The light emitting diode lamp as claimed in claim 1, wherein the heat conductive pole is made of a heat conductive but electrically insulating material.

3. The light emitting diode lamp as claimed in claim 2, wherein the material for the heat conductive pole is thermal grease.

4. The light emitting diode lamp as claimed in claim 1, wherein the heat conductive pole is made of a heat conductive and electrically conductive material.

5. The light emitting diode lamp as claimed in claim 1 further comprising a heat dissipating device, the heat conductive layer is in thermal connection with the heat dissipating device.

6. The light emitting diode lamp as claimed in claim 5, wherein the heat dissipating device comprises a base and a plurality of fins extending from the base, the base of the heat dissipating device being mounted on the heat conductive layer of the circuit board.

7. The light emitting diode lamp as claimed in claim 1, wherein the circuit board further comprises a heat conductive but electrically insulating layer, the insulating layer being sandwiched between the bonding layer and the heat conductive layer.

8. The light emitting diode lamp as claimed in claim 1, wherein the substrate of the at least one light emitting diode comprises a first electrode, a second electrode and a pad, the circuit layer comprising at least one mounting area corresponding to the at least one light emitting diode, the at least one mounting area comprising a first electrode corresponding to the first electrode of the substrate, a second electrode corresponding to the second electrode of the substrate, and a heat conductive section corresponding to the pad, the first and the second electrodes of the substrate being electrically connected with the first and the second electrodes of the at least one mounting area, respectively, the pad being attached to the heat conductive section, the heat conductive pole being located in the heat conductive section.

9. The light emitting diode lamp as claimed in claim 1, wherein the at least one light emitting diode further comprises a mounting base, a light emitting diode chip and an encapsulation material, the mounting base defining a recess therein, the light emitting diode chip being disposed in the recess, the encapsulation material encapsulating the light emitting diode chip in the recess.
